(19) United States
(12) Patent Application Publication
(10) Pub. No.: US 2017/0365236 A1
(43) Pub. Date: Dec. 21, 2017

(54) DISPLAY-LAYER UPDATE DEFERRAL

(71) Applicant: Qualcomm Innovation Center, Inc., San Diego, CA (US)

(72) Inventors: Dileep Marchya, Hyderabad (IN); Mastan Manoj Kumar Amara Venkata, San Diego, CA (US); Nagamalleswararao Ganji, San Diego, CA (US); Panneer Arumugam, San Diego, CA (US)

(21) Appl. No.: 15/188,382

(22) Filed: Jun. 21, 2016

(51) Int. Cl. G09G 5/377; G06F 3/041; G06F 1/32; G06T 1/20; G09G 5/36

(52) U.S. Cl. CPC G09G 5/377; G06T 1/20; G09G 5/363; G06F 1/3265; G06F 3/0412; G09G 2330/023

(57) ABSTRACT

Methods and apparatus for displaying layers on a display of a computing device are disclosed. The method includes creating layers from graphical data and assigning a priority to each of the layers. The layers are displayed on the display of the computing device, and in a current draw cycle, any layers assigned an urgent priority are updated. In addition, updates are applied to layers near a touch area of the display and updates to other layers ae deferred until a predefined event occurs.

### FIELD OF THE INVENTION

The present invention relates to computing devices. In particular, but not by way of limitation, the present invention relates to apparatus and methods for improving power utilization in connection with displaying content on computing devices.

### BACKGROUND OF THE INVENTION

Computing devices such as smartphones, netbooks, gaming devices, PDAs, and laptop computers are now ubiquitous. And these devices now very commonly include a display (e.g., touchscreen display) and associated software and hardware that provide a user interface for users to request and view displayed.

On these computing devices, it is common for a user to navigate from one application (also referred to herein as app) to another application, and navigation between multiple pages within an application is also common. In some hardware designs, a partial refresh of the display may be performed, but support is provided for only updating one region—not multiple smaller regions. In computed devices with these types of hardware designs, a large region of the total displayed content is recomposed even though there may only be a slight change to the displayed content. As a consequence, the recomposition of a large region of the display unnecessarily utilizes system resources such as power and processor time.

### SUMMARY

An aspect of the invention may be characterized as a method for displaying layers on a display of a computing device, the method comprising creating layers from graphical data and assigning a priority to each of the layers. The layers are displayed on the display of the computing device and, in a current draw cycle, any layers assigned an urgent priority and any layers near a touch area of the display are updated. Updates to other layers are deferred until a predefined event occurs. The predefined event may include a threshold number of draw cycles occurring and may include an area of a layer exceeding a threshold size relative to an area of the display.

Another aspect may be characterized as a computing device that includes one or more producers of graphics data and a compositor configured to create layers from the graphics data. A priority assignment module assigns priorities to each of the layers, and a composer is configured to display frames of the layers on a display screen. An update deferral module is configured to prompt the composer to defer updates to one or more of the layers based upon the assigned priorities.

Yet another aspect may be characterized as a non-transitory, tangible computer readable storage medium, encoded with processor readable instructions to perform a method for creating layers from graphical data. The method includes creating layers from graphical data and assigning a priority to each of the layers. The layers are displayed on the display of the computing device and, in a current draw cycle, any layers assigned an urgent priority and any layers near a touch area of the display are updated. Updates to other layers are deferred until a predefined event occurs. The predefined event may include a threshold number of draw cycles occurring and may include an area of a layer exceeding a threshold size relative to an area of the display.

### BRIEF DESCRIPTION OF THE DRAWINGS

FIG. 1 is a block diagram depicting a computing device according to aspects of the present invention;

FIG. 2 is a diagram depicting layers displayed on a computing device;

FIG. 3 is a is a flowchart depicting a method that may be traversed in connection with embodiments disclosed herein;

FIG. 4 depicts multiple screenshots of a computing device over time to illustrate aspects of deferred updating; and

FIG. 5 is a block diagram depicting physical components of an exemplary computing device.

### DETAILED DESCRIPTION

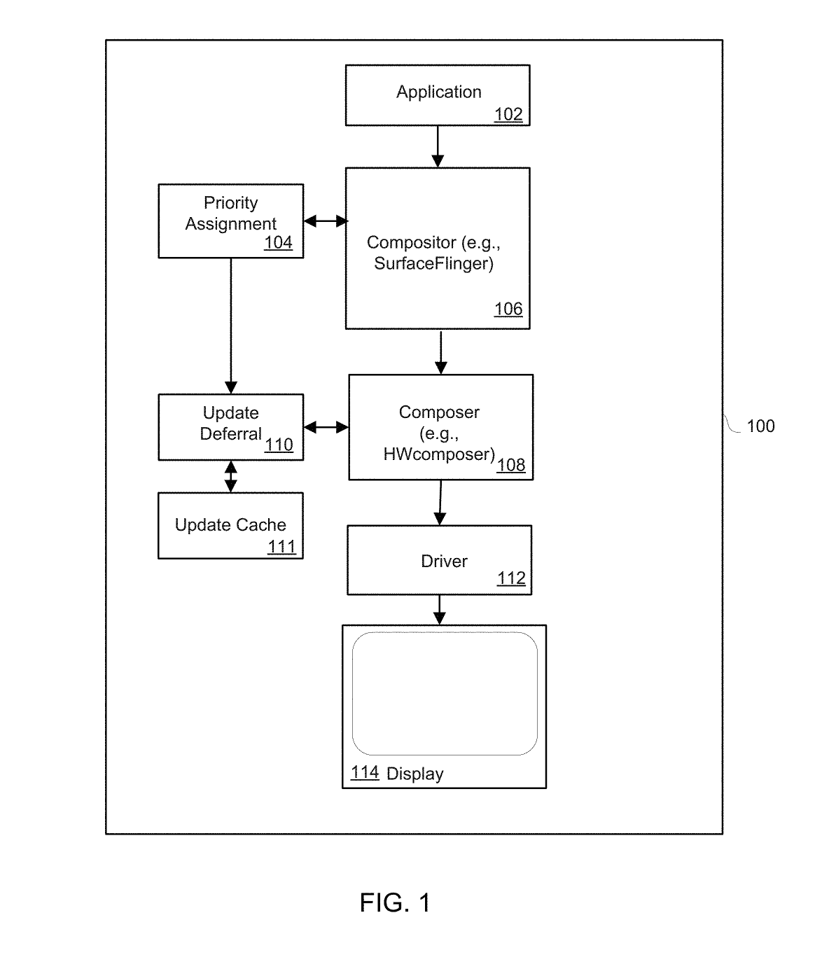

Referring first to FIG. 1, it is a block diagram depicting an embodiment of an exemplary computing device 100. As discussed further herein, the exemplary computing device 100 provides an improved user experience and/or reduced power consumption by reducing processor usage and power usage associated with unnecessary display-layer updates. In some embodiments for example, display-updates that are not urgent (as discussed in more detail further herein) are delayed until a time threshold expires or until one or more events occur that make updating the display more desirable (e.g., to maintain a user's experience). According to an aspect, the computing device 100 may operate with underlying hardware, which only supports updating one region (not multiple smaller regions) by avoiding refresh updates in the area which did not change (but became subject to change due to the underlying hardware design).

As shown, the computing device 100 includes an application 102 in communication with a compositor 106 that is in communication with a composer 108. As shown, the compositor 106 is also coupled to a priority assignment module 104, and the composer 108 is coupled to an update deferral module 110. In addition, a driver 112 is coupled both to the composer 108 and a display 114.

The depiction of these components is logical and is not intended to be an actual hardware diagram. For example, the division of the priority assignment module 104, the compositor 106, the composer 108, and update referral module 110 is for exemplary purposes only, and each depicted component may be further separated into constituent components. But it should also be recognized that the components may be integrated to such an extent that each component may not be separately recognizable in actual implementation. Moreover, the components may be realized by hardware, software in connection with hardware, firmware, or a combination thereof. And although not required, the priority assignment module 104 and the update deferral module 110 may be realized by additions and modifications readily apparent to one of ordinary skill in the art (in light of this disclosure) to existing computing devices. For example, the embodiment depicted in FIG. 1 may be realized by modifying user-level and kernel level components of an ANDROID-based computing device.

The computing device 100 may be realized by a variety of devices such as smartphones, netbooks, gaming devices, PDAs, tablets, and laptop computers. The application 102 is an example of a variety of different types of producers of graphics data that user may view or interact with to request, retrieve and view content such as a web browser, or any of a variety of other applications that utilize displayed content (e.g., gaming, utility, and educational apps).

The compositor 106 generally manages multiple surfaces from the application 102 and various other apps. Although not required, the compositor 106 may be realized by the SurfaceFlinger module (or a derivative of the SurfaceFlinger module) of the ANDROID framework. In operation, for example, there may be many running applications with independent surfaces that are being rendered. The compositor 106 determines what will be shown on the display 114 and provides overlays as needed. An aspect of the role of the compositor 106 is to accept buffers of data from multiple sources (e.g., the application 102) and composite them for later display.

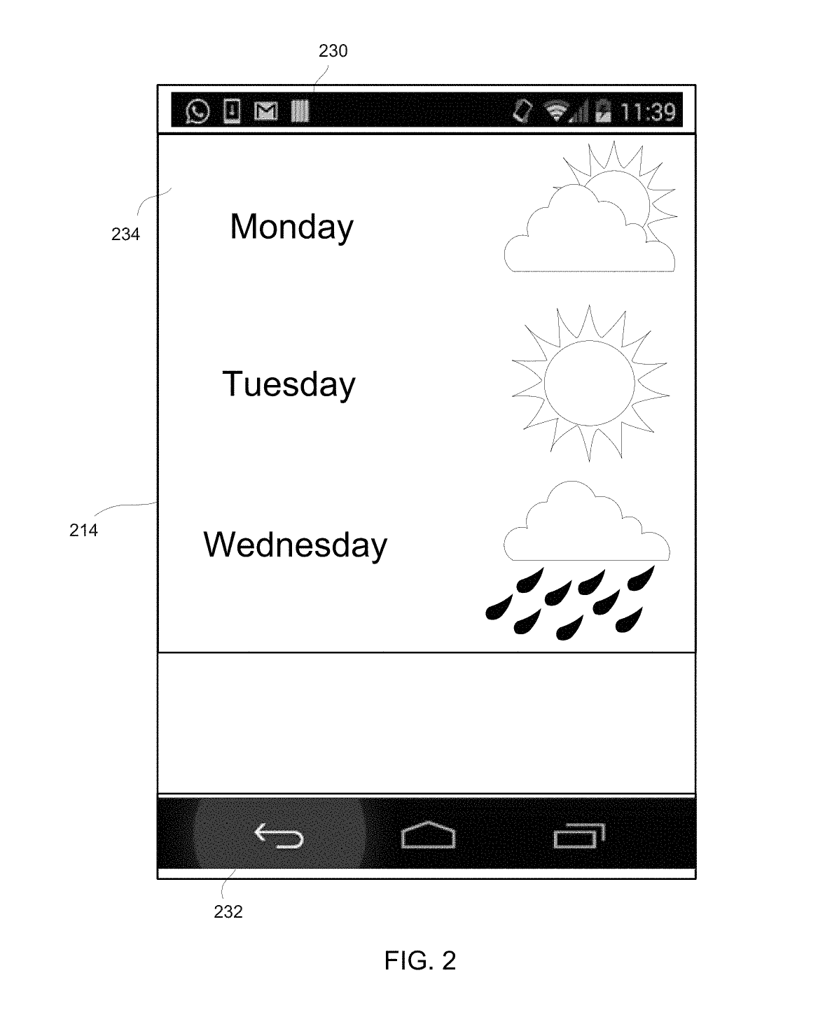

When an app comes to the foreground (e.g., because the user selects the app or an event (e.g., a text message being received), prompts the app to the foreground), the compositor 106 creates a “layer.” Referring briefly to FIG. 2 for example, there are commonly three or more layers on the display 214 at any time: a status layer 230 at the top of the screen, a navigation layer 232 at the bottom or side, and application's user interface 234. Some apps may have more or less layers, and each layer can be updated independently. The depiction of FIG. 2 is just one example of what may be displayed at any time on a computing device.

The priority assignment module 104 in this embodiment functions to assign a priority to each of the layers where the priority is one of a plurality of priorities including one of an “urgent” priority and a “normal” priority. For example, each layer may be assigned a priority of either “normal” or urgent based on a number frames per second that change in the content in each layer. For example, unless it is likely that a particular layer will be updated in 100 milliseconds, the particular layer may be assigned a normal priority. And if it is likely that the particular layer will be updated in less than 100 milliseconds, the particular layer may be assigned an urgent priority. As a default, layers may be assigned a normal priority, and as discussed below, in many modes of operation, updates for urgent layers are applied in the current draw cycle. For example, layers that include soft-key press animations and cursor blinks may be prioritized as urgent, while other layers that include content that is static over several draw cycles may be assigned a normal priority.

The composer 108 in this embodiment operates as a hardware abstraction layer (HAL) that is used by the compositor 106 to perform composition using hardware resources such as a 3D graphics processing unit (GPU) or a 2D graphics engine (not shown). In general, the compositor 106 determines how to composite buffers with the available hardware on the computing device. In the context of an ANDROID-based computing device, the composer 108 may be realized using the ANDROID HWcomposer (or a derivative thereof). But in this embodiment, the composer 108 operates in connection with the update deferral module 110 to defer updates to displayed layers.

In general, the update deferral module 110 operates to apply deferral logic in order to defer updates to some of the displayed layers. For example, the update deferral module 110 may apply urgent updates in the current draw cycle and updates which are in close proximity to a user touch area in the current draw cycle. For example, soft key press animation, cursor blinks, etc. may be updated in the current draw cycle.

In general, the update deferral module may operate to isolate updates (e.g., “dirty rectangles”) of the layers which are near a user touch area, and the dirty rectangles are unionized. A balance is maintained between having a small unionized rectangle size while avoiding the deferral of too many updates.

For example, a rectangle may be unionized to obtain a small final rectangle near a touch area. The remaining portions may be deferred and taken in one draw cycle or distributed across multiple draw cycles depending upon their positions. While applying a deferred update, the overall updated area may be minimized.

If an update is deferred, the update cache 111 may hold the update data until the update is performed. In some embodiments, references to distant updates are held for a threshold amount of time (e.g., 15 draw cycles).

In operation, the update deferral module 110 may apply a pending update that has been deferred if an event occurs that makes an update more appropriate. For example, a pending update may be applied in a subsequent draw cycle when there is no update in a next cycle.

Another instance where an update that was being deferred is applied is when an area of the layer to be updated increases in size to exceed a threshold (also referred to as a threshold size area). This threshold may be set in terms of the layer's size relative to the size of the screen of the display 114. For example, the threshold may be set to 75% so that an update for a layer is no longer deferred when the size of the layer exceeds 75% of the screen size.

Yet another event that may prompt a deferred update to be immediately displayed is when a threshold time has elapsed since a last update. As discussed above, the threshold may be set in terms of draw cycles (e.g., 15 draw cycles).

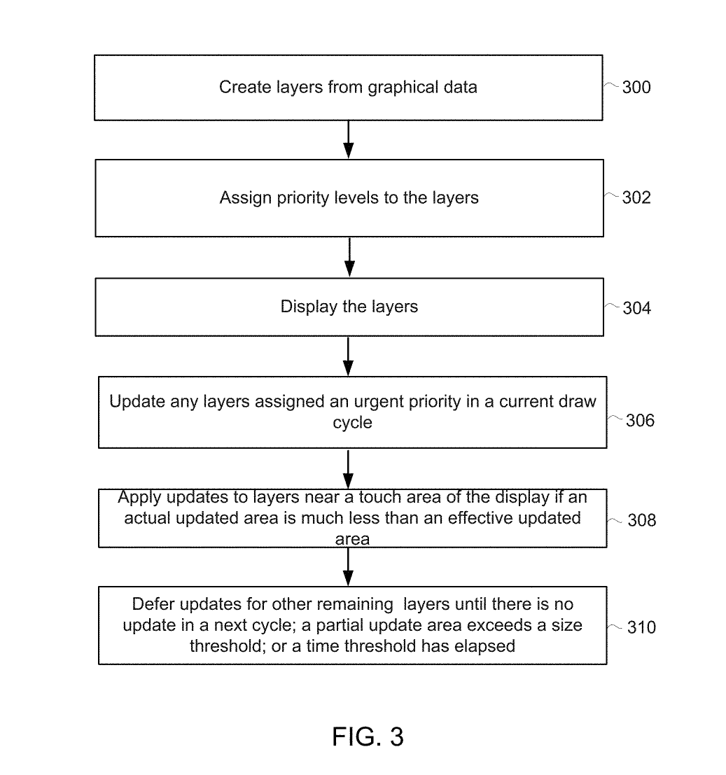

Referring next to FIG. 3, shown is a flowchart depicting a method that may be traversed in connection with the embodiment depicted in FIG. 1. As shown, in response to one or more producers of graphics data (such as the application 102) providing graphics data to the compositor 106 (e.g., via a buffer queue, not shown), the compositor 106 creates layers from the graphical data (Block 300), and the priority assignment module 104 assigns a priority to each of the layers (Block 302). For example, some layers are assigned an urgent status while all others are assigned a normal status. The layers are then displayed on the display 114 (Block 304), and any layers assigned an urgent priority are updated in a current draw cycle (Block 306).

In addition, if an actual updated area (e.g., a sum of all dirty rectangles) is much less than an effective updated area (the union of all dirty rectangles), then updates are applied to layers near a touch area of the display (Block 308). While pressing the touch area, the user's focus will be centered around the touch area, so immediate updates may be applied to the layer near the touch area. In contrast, the user will unlikely notice changes happening which are far from the touch point; thus updates to the far away layers may be deferred until a predefined event occurs (Block 310).

For the non-urgent layers far away from the touch point, references to the distant updates may be held for a threshold time (e.g., 15 draw cycles), and pending updates for other remaining layers (e.g., layers assigned a normal priority) may be deferred and applied in a subsequent draw cycle when either a) a tracking of scheduled updates indicates there is no update in a next cycle; b) a partial update area eventually becomes larger than a threshold size area (e.g., greater than 75% of a display of the computing device); or, c) a threshold time has elapsed (Block 310). For example, an area of each of the layers may be tracked and when a partial update area (an area of a portion of the display) exceeds a threshold size area, the update to the partial update area may be applied. Also, a timer may be initiated after updates to all the layers are applied, and all of the layers may be updated when the time threshold is reached. The time threshold may be measured in terms of a number of draw cycles.

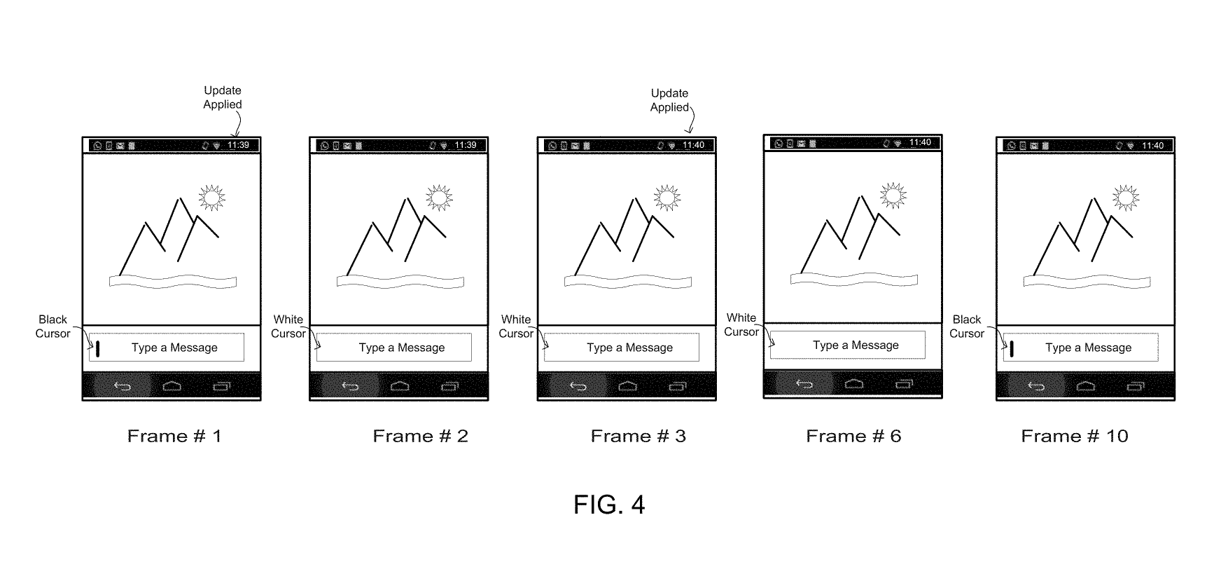

Referring to FIG. 4, shown is a display of a mobile device in which a cursor alternates between black and white over several frames. The cursor may blink at 2-4 frames per second (fps), while the display refreshes at 60 fps. So, the cursor will only turn black every 15-30 draw cycles. For instance, in a first draw cycle (in frame 1) the cursor is black, and there is an update because it is the first time the cursor is displayed. In the second draw cycle the cursor turns white so there is an update to the layer displaying the cursor, but the update to the layer with the clock is deferred until the third frame. But the layer displaying the cursor in the third frame is not updated because the cursor remains white. As shown, in the tenth draw cycle, the cursor turns black again, so this cycle has an update to the layer displaying the cursor.

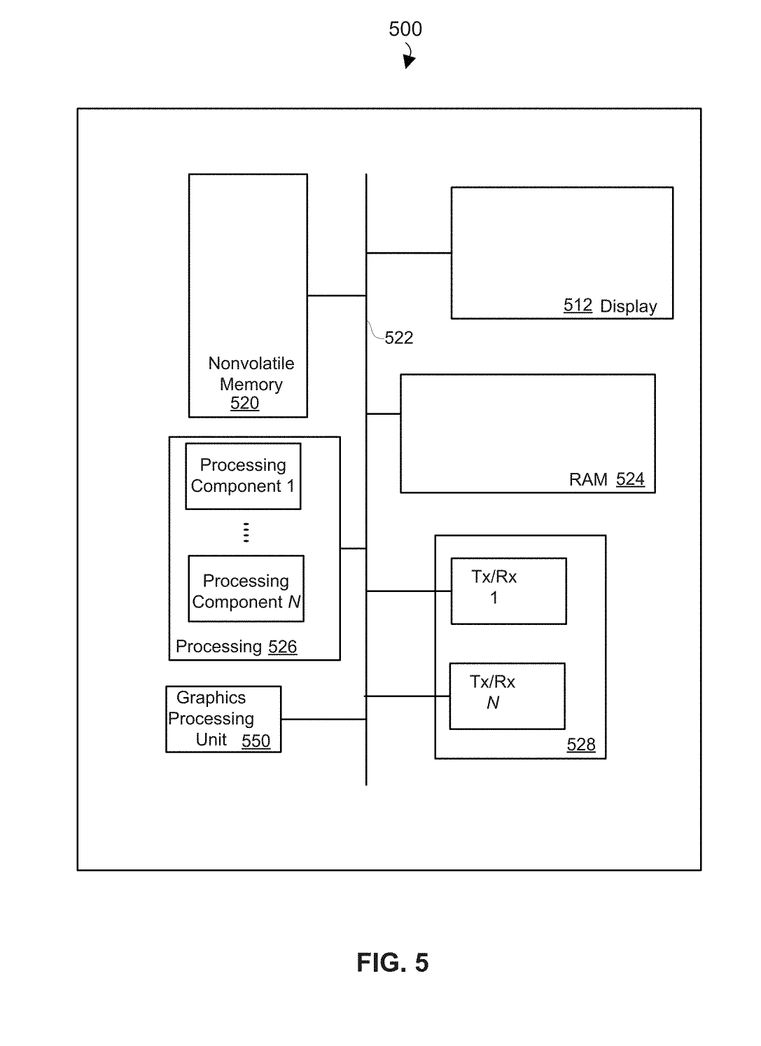

Referring next to FIG. 5, shown is a block diagram depicting physical components that may be utilized to realize one or more aspects of the embodiments disclosed herein. As shown, in this embodiment a display portion 512 and nonvolatile memory 520 are coupled to a bus 522 that is also coupled to random access memory (“RAM”) 524, a processing portion (which includes N processing components) 526, a field programmable gate array (FPGA) 527, and a transceiver component 528 that includes N transceivers. Although the components depicted in FIG. 5 represent physical components, FIG. 5 is not intended to be a detailed hardware diagram; thus many of the components depicted in FIG. 5 may be realized by common constructs or distributed among additional physical components. Moreover, it is contemplated that other existing and yet-to-be developed physical components and architectures may be utilized to implement the functional components described with reference to FIG. 5.

The display 512 generally operates to provide a user interface for a user. The display 512 may be realized, for example, by a liquid crystal display (LCD) or AMOLED display, and in several implementations, the display 512 is realized by a touchscreen display. The display 512 may be utilized to realize, at least in part, the display 114 described with reference to FIG. 1 to display webpages (and down sampled versions of webpages while webpages are loading). In general, the nonvolatile memory 520 is non-transitory memory that functions to store (e.g., persistently store) data and processor executable code (including executable code that is associated with effectuating the methods described herein). In some embodiments for example, the nonvolatile memory 520 includes bootloader code, operating system code, file system code, and non-transitory processor-executable code to facilitate the execution of functional components depicted in FIG. 1 and the methods described herein including the method described with reference to FIG. 2. Moreover, the non-volatile memory may be utilized to realize the counter-URL cache 108 described with reference to FIG. 1.

In many implementations, the nonvolatile memory 520 is realized by flash memory (e.g., NAND or ONENAND memory), but it is contemplated that other memory types may be utilized as well. Although it may be possible to execute the code from the nonvolatile memory 520, the executable code in the nonvolatile memory is typically loaded into RAM 524 and executed by one or more of the N processing components in the processing portion 526.

The N processing components in connection with RAM 524 generally operate to execute the instructions stored in nonvolatile memory 520 to enable the display of graphical content (and the deferred updating of graphical layers). For example, non-transitory processor-executable instructions to effectuate the methods described with reference to FIG. 5 may be persistently stored in nonvolatile memory 520 and executed by the N processing components in connection with RAM 524. As one of ordinarily skill in the art will appreciate, the processing portion 526 may include a video processor, digital signal processor (DSP), graphics processing unit (GPU), and other processing components.

In addition, or in the alternative, the FPGA 327 may be configured to effectuate one or more aspects of the methodologies described herein (e.g., the methods described with reference to FIG. 3). For example, non-transitory FPGA-configuration-instructions may be persistently stored in nonvolatile memory 520 and accessed by the FPGA 527 (e.g., during boot up) to configure the FPGA 527 to effectuate functions of one or more of the components depicted in FIG. 1 including the priority assignment module 104 and update deferral module 110.

The depicted transceiver component 528 includes N transceiver chains, which may be used for communicating with external devices via wireless or wireline networks. Each of the N transceiver chains may represent a transceiver associated with a particular communication scheme (e.g., WiFi, CDMA, Bluetooth, NFC, etc.). The transceiver chains may be utilized to request and receive webpages and send form data as described herein. In many embodiments, the computing device 100 is a wireless computing device that utilizes wireless transceiver technology, but the computing device 100 may also be implemented using wireline technology.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

FIG. 5 depicts an example of constructs that may be utilized to implement embodiments disclosed herein, but the various illustrative logical blocks, modules, and circuits described in connection with the embodiments disclosed herein may be implemented or performed in a variety of different ways. For example, the various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, erasable programmable read-only memory (EPROM) memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for displaying layers on a display of a computing device, the method comprising:
creating layers from graphical data;
assigning a priority to each of the layers based on a number of frames per second that change in each layer, the priority being one of a plurality of priorities including an urgent priority and a normal priority;
displaying the layers on the display of the computing device;
updating, in a current draw cycle, any layers assigned an urgent priority and any layers near a touch area of the display; and
deferring updates to layers assigned the normal priority until a predefined event occurs.

2. The method of claim 1, wherein assigning the priority includes assigning the normal priority to a particular layer unless it is likely that the particular layer will change in less than 100 milliseconds.

3. The method of claim 1, including:
initiating a timer after updates to all the layers are applied;
wherein deferring includes updating all of the layers when a time threshold is reached.

4. The method of claim 3, wherein the time threshold is a number of draw cycles.

5. The method of claim 1, including:
tracking an area of each of the layers;
wherein the predefined event includes a layer exceeding a threshold size area.

6. The method of claim 1, including:
tracking scheduled updates; and
applying an update to a layer when there is no update in a next cycle.

7. A computing device, the computing device including:
one or more producers of graphics data;
a compositor configured to create layers from the graphics data;
a priority assignment module to assign a priority to each of the layers based on a number of frames per second that change in each layer, the priority being one of a plurality of priorities including an urgent priority and a normal priority;
a composer configured to display frames of the layers on a display screen; and
an update deferral module configured to prompt the composer to defer updates to one or more of the layers based upon the assigned priorities.

8. The computing device of claim 7, wherein the priority assignment module is configured to assign the normal priority to a particular layer unless it is likely that the particular layer will change in less than 100 milliseconds.

9. The computing device of claim 7, wherein the compositor and composer include a SurfaceFlinger module and HWComposer, respectively.

10. The computing device of claim 9, wherein the update deferral module is configured to:
update, in a current draw cycle, any layers assigned an urgent priority;
applying updates to layers near a touch area of the display; and
defer updates to other layers until a predefined event occurs.

11. A non-transitory, tangible computer readable storage medium, encoded with processor readable instructions to perform a method for displaying layers on a display of a computing device, the method comprising:
creating layers from graphical data;
assigning a priority to each of the layers based on a number of frames per second that change in each layer, the priority being one of a plurality of priorities including an urgent priority and a normal priority;
displaying the layers on the display of the computing device;
updating, in a current draw cycle, any layers assigned an urgent priority and any layers near a touch area of the display; and
deferring updates to layers assigned the normal priority until a predefined event occurs.

12. The non-transitory, tangible computer readable storage medium of claim 11, wherein assigning the priority includes assigning the normal priority to a particular layer unless it is likely that the particular layer will change in less than 100 milliseconds.

13. The non-transitory, tangible computer readable storage medium of claim 11, wherein the method includes:
initiating a timer after updates to all the layers are applied;
wherein deferring includes updating all of the layers when a time threshold is reached.

14. The non-transitory, tangible computer readable storage medium of claim 13, wherein the time threshold is a number of draw cycles.

15. The non-transitory, tangible computer readable storage medium of claim 11, the method including:
tracking an area of each of the layers;
wherein the predefined event includes a layer exceeding a threshold size area.

16. The non-transitory, tangible computer readable storage medium of claim 11, the method including:
tracking scheduled updates; and
applying an update to a layer when there is no update in a next cycle.
